(19) United States
(12) Patent Application Publication
(10) Pub. No.: US 2008/0172790 A1
(43) Pub. Date: Jul. 24, 2008

(54) TREATMENT TABLE FOR PATIENT TREATMENT

(75) Inventor: Herbert Brustmann, Wolfratshausen (DE)

Correspondence Address: SEED INTELLECTUAL PROPERTY LAW GROUP PLLC, 701 FIFTH AVE, SUITE 5400, SEATTLE, WA, 98104, US

(73) Assignee: BRUMABA KG, Wolfratshausen (DE)

(21) Appl. No.: 11/950,268

(22) Filed: Dec. 4, 2007

(30) Foreign Application Priority Data
Dec. 5, 2006 (DE) 10 2006 057 306.4

(51) Int. Cl. A61G 7/00

(52) U.S. Cl. 5/616

(57) ABSTRACT

Described is a treatment table for patient treatment comprising a plurality of table elements and a positioning device for selectively setting the position of a respective table element, wherein the positioning device has a plurality of electrical switches or switching contacts with associated actuating portions with which selective positioning movements of the positioning device are controllable, wherein the positioning device is in the form of a foot switch (11) and has at least one actuating lever (1) whose movements which are predetermined in given directions by a guide device (2) can be transmitted to at least two switches (3) or at least two switching contacts.

The invention concerns a treatment table for patient treatment as set forth in the classifying portion of claim 1.

A treatment table of that kind is known from EP 0 873 740 B1.

That treatment table has a plurality of table elements which can be moved selectively into desired positions by means of a positioning device. That means that the treatment table can be adapted to different therapies which are to be carried out on the patient. By means of electrical switches or switching contacts, the desired positioning movements are transmitted to the table elements with associated actuating portions which are preferably in the form of piston/cylinder devices.

The object of the invention is to provide a treatment table of the kind set forth in the opening part of this specification, in which reliable switching functions are guaranteed.

According to the invention that object is attained by the features of claim 1.

In the invention the positioning device having the switches or switching contacts has a foot switch. It has at least one and in particular three actuating levers. The movements of each actuating lever are predetermined in given directions, by means of a guide device. Those movements are transmitted to at least two switches or two switching contacts. Preferably two switches or two switching contacts with associated switching circuits for the respective switching function with which the selectively chosen positioning movement is implemented are provided for each lever movement. That provides an overload-safe foot switch for the treatment table. As will be described in detail hereinafter the foot switch whose actuating levers are to be moved in the manner of a joystick can provide a plurality of functions for the positioning movements, in a very compact space. As at least two switches or switching contacts which are to be triggered simultaneously are provided for each respective function triggering, function triggering is effected even when one of the switches is defective. For function triggering with the present invention it is necessary for all switches which are required for the respective function triggering and in particular two switches to be actuated and activated. If one of the two switches is defective and consequently is in a permanently triggering switching position, no function triggering is implemented. For that purpose, as already mentioned, it is necessary for all associated switches or switching contacts and in particular the two switches or switching contacts to be activated.

As will also be described in detail hereinafter the foot switch of the treatment couch involves an overload-safe and compact mode of operation. By virtue of the above-discussed mode of operation the foot switch also represents a safety switch.

Preferably, fixed to the respective actuating lever is a resiliently yielding movement transmission device which transmits the movements of the actuating lever to a mechanical actuating device which selectively actuates the two switches or switching contacts in dependence on the respective direction of movement of the actuating lever or the position thereof. By virtue of the resiliently yielding nature of the movement transmission device and indirect, overload-safe actuation of the switches or switching contacts by way of the mechanical actuating device, the arrangement provides for long-lived functional reliability and consequently freedom from maintenance of the device, even under rough operating conditions, in particular upon foot actuation of the actuating lever. The actuating device which is dependent on the direction of movement or position of the actuating lever and which selectively actuates the switches or switching contacts makes it possible to achieve a defined triggering force and also inexpensive use of standard components in relation to the switches or switching contacts.

The mechanical actuating device by way of which indirect switch actuation takes place can have a plurality of actuating portions which are to be moved out of a rest position into an actuating position by the resiliently yielding movement transmission device. Those actuating portions can be resiliently biased into their starting position (rest position). For that purpose the actuating portions can be in the form of spring elements which are assembled to form a plate-shaped component which is arranged fixedly with respect to the housing.

Preferably the movement transmission device comprises a foam material and can be in the form of a cylindrical body.

The actuating lever can be moved in a defined predetermined fashion by the guide device, preferably in four directions of movement. Those directions of movement are respectively spaced from each other at a right angle and, upon installation of the device in a foot switch, can lie in the horizontal and vertical directions.

In order to achieve effective transmission of movement from the actuating lever to the actuating device, the movement actuating device can be fixed at the end or in the proximity of the end of the actuating lever. In that case the actuating lever is preferably mounted movably about a pivot point which is fixed with respect to the housing and which is arranged at a spacing from the movement transmission device.

The invention will be described in greater detail hereinafter by means of embodiments by way of example with reference to the Figures in which:

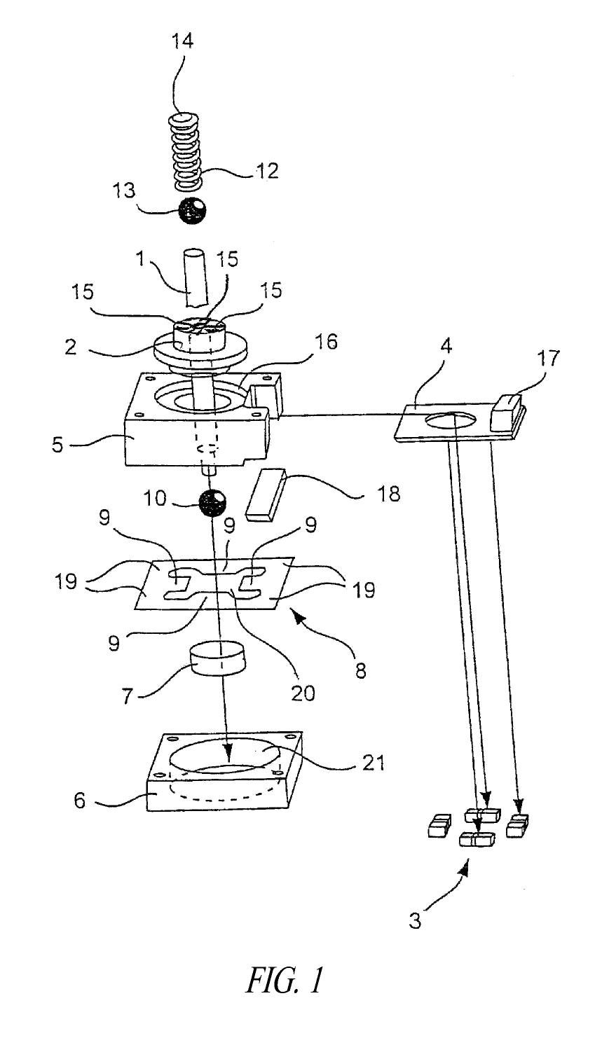

FIG. 1 shows a perspective exploded view of an embodiment of a foot switch which can be used in the invention,

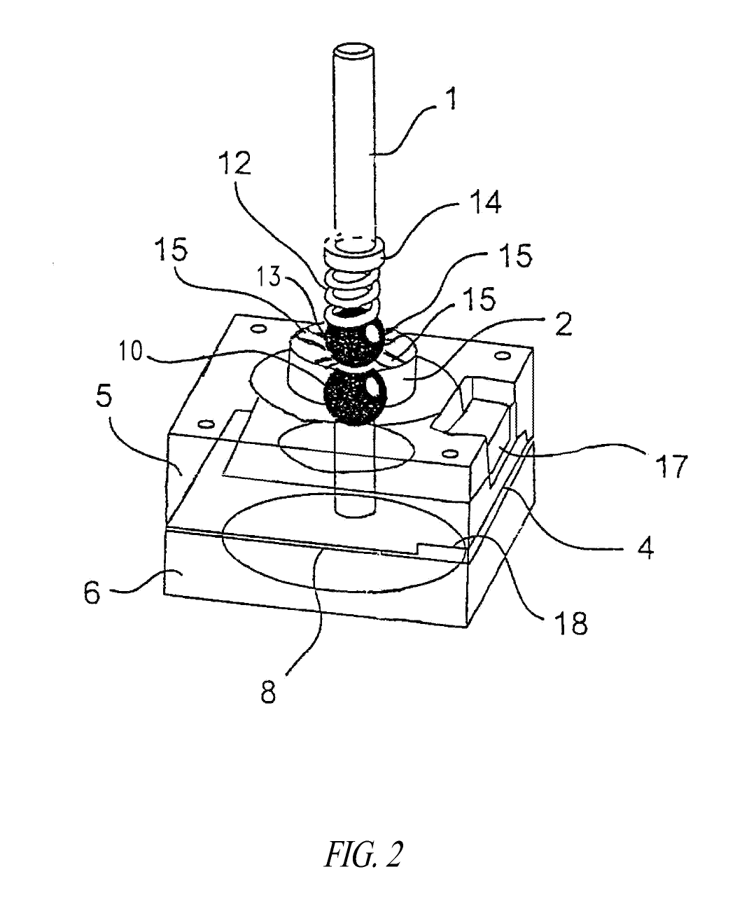

FIG. 2 shows the embodiment of FIG. 1 in the assembled condition,

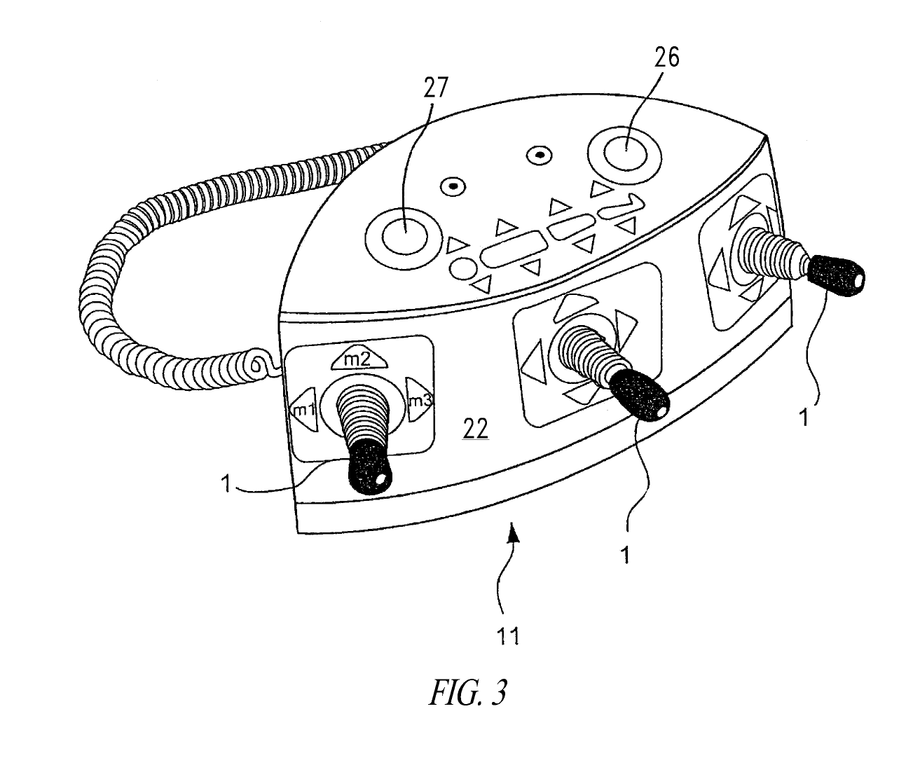

FIG. 3 shows a foot switch in which three embodiments of FIGS. 1 and 2 are arranged, and

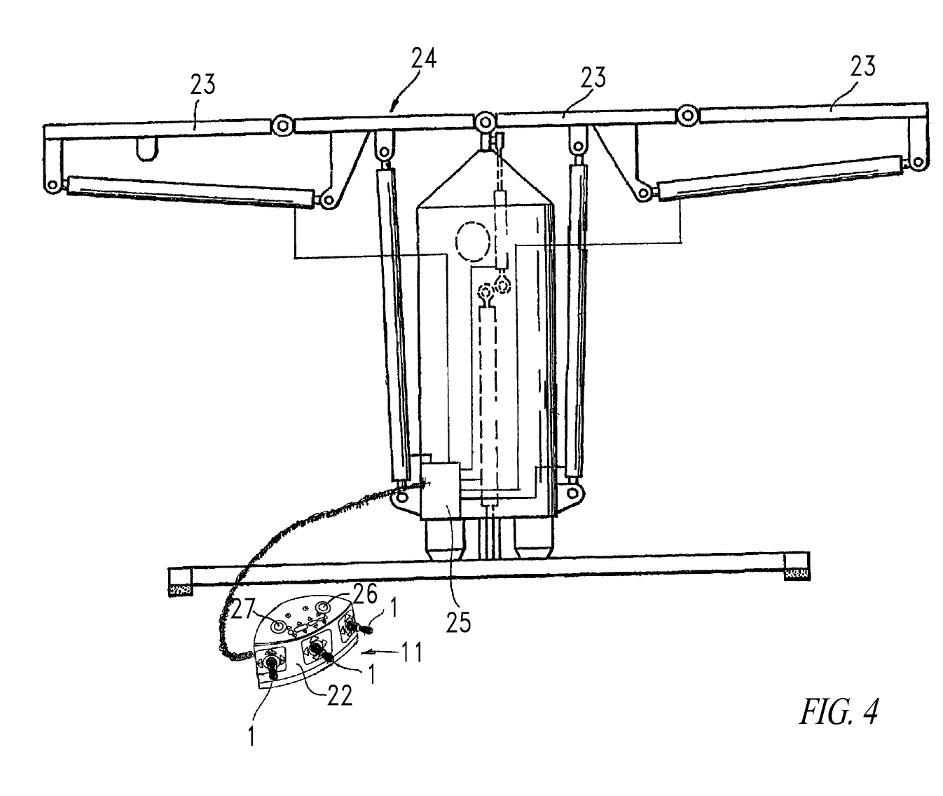

FIG. 4 shows a treatment table in which the foot switch of FIG. 3 is employed.

The embodiment of a foot switch as illustrated in the Figures has an actuating lever 1. The actuating lever 1 is pivotable about a pivot point 10 which is mounted fixedly with respect to a housing. The housing comprises two housing portions which in the illustrated embodiment are formed by an upper housing portion 5 and a lower housing portion 6. In the assembled condition (FIG. 2) the two housing portions 5 and 6 are connected together by screw connections. The pivot point 10 can be formed by an apertured ball through which the actuating lever is fitted. The pivot point 10 can be mounted rotatably on the housing, in particular on the upper housing portion 5 or in a guide device 2. The guide device 2 is supported in an upwardly disposed recess 16 in the upper housing portion 5. The guide device 2 includes a recessed guide block with guide grooves 15 which extend perpendicularly to each other and along which a guide ball 13 which surrounds the actuating lever 1 is guided in the movement of the actuating lever 1. The guide grooves 15 in the guide device 2 define the directions of movement, along which the actuating lever 1 can be actuated.

The guide ball 13 is urged into the guide grooves 15 of the guide device 2 by means of a biasing spring 12 which is supported against the actuating lever 1 by means of a spring abutment 14 in the form of a securing ring or circlip. The biasing spring 12 can be in the form of a coil spring, as illustrated, which surrounds the actuating lever 1. The actuating lever 1 is biased in a direction towards its starting position as shown in FIG. 2, by the biasing force of the biasing spring 12. For that purpose the guide block of the guide device 2 can be in the form of a part-spherical recess in which the guide grooves 15 extend perpendicularly to each other.

The guide device 2 is disposed in an opening 16 which is in the form of a recess at the top side of the housing portion 5. The guide device is fitted in positively locking relationship into the opening 16. Disposed at the underside of the upper housing portion 5 is a printed circuit board 4 with electrical and electronic components which, in dependence on the respective position or movement of the actuating lever 1, cause given functions on the connected item of equipment. The electrical connection to the item of equipment to be operated can be made by way of a plug connector strip 17 which is provided on the printed circuit board 4 and which is disposed in a suitably shaped recess in the housing when the arrangement is assembled (FIG. 2).

Disposed at the underside of the printed circuit board 4 are switches 3 which in the illustrated embodiment are in the form of microswitches. Those microswitches 3 are arranged in paired relationship in four positions on the printed circuit board 4.

An actuating device 8 in plate form is disposed beneath the switches 3 at a given spacing in the axial direction of the actuating lever 1. The actuating device 8 is fixed to the underside of the upper housing portion 4 at four fixing points 19 disposed in the corners. The spacing from the switches 3 fixed to the underside of the printed circuit board 4 is provided by the printed circuit board being supported in the upper housing portion 5 in a suitably shaped opening with support shoulders engaging the edges of the printed circuit board, and being fixed with respect to the housing by means of a fixing plate 18. The fixing plate 18 has at its ends bores through which the screw connections with which the two housing portions 5 and 6 are connected together pass. Those screw connections also fix at the corners in the fixing points 19 the actuating device 8 which is in plate form and which is disposed between the underside of the upper housing portion 5 and the top side of the lower housing portion 6.

The plate-form actuating device 8 has a central opening 20 passing therethrough, through which projects the part of the actuating lever 1, which is beneath the rotary pivot point 10. Actuating portions 9 which have resiliently elastic properties project into that through opening 20. The actuating portions 9 are associated with the respective pairs of switches 3. The actuating portions 9 are connected together integrally to provide the actuating device 8 which is in plate or frame form. In the rest condition or in the starting position, the actuating portions 9 which are of a tongue-like configuration are arranged at a spacing from the switches 3 or switching contacts.

A movement transmission device 7 is fixed beneath the actuating device 8 to the part of the actuating lever 1, which projects through the opening 20. The movement transmission device 7 comprises a resiliently elastic material, for example foam. In the assembled condition (FIG. 2) the movement transmission device 7 is disposed in a cup-shaped opening 21 in the lower housing portion 6. The movement transmission device 7 can be in the form of a flat cylindrical body as shown in FIG. 1. The movement transmission device 7 is fixed to the lower end of the actuating lever 1 which projects into the opening 21. When the actuating lever 1 is pivoted along one of the guide channels or guide grooves 15 in the guide device 2, the lower end of the actuating lever 1 and therewith the movement transmission device 7 are also pivoted within the opening 21. In that case the movement transmission device 7 presses from below against one of the actuating portions 9 and moves it upwardly by virtue of its resiliently elastic deformability so that one of the pairs of switches 3 is actuated. Instead of the pairs of switches 3 it is also possible to provide only one respective switch. In addition it is possible to provide switching contacts in each case individually or in paired relationship or in a larger given number on the printed circuit board 4. Instead of the flat cylindrical shape of the movement transmission device 7 it is also possible to adopt a star-shaped configuration or another suitable shape which is appropriate for transmitting movement to the respectively associated actuating portion 9 in dependence on the respective position of the actuating lever 1. The respective switches 3 or switching contacts on the printed circuit board 4 are actuated in a careful gentle fashion by virtue of the resiliently elastic nature of the movement transmission device 7. In addition, the resiliently elastic transmission of movement to the actuating portions 9 provides for a loading which acts in a gentle careful manner in relation to the components involved, upon indirect actuation of the switches 3 or switching contacts. When the actuating lever 1 is released it is automatically moved back into its starting position, as already explained above.

By virtue of the above-described gentle and careful transmission of movement the actuating lever 1 can be actuated even in relatively rough operation when using a foot switch 11, as shown in FIG. 3. The foot switch 11 shown in FIG. 3 includes three embodiments of FIGS. 1 and 2 so that a large number of functions which can also include memory functions to be triggered by for example a memory switch 26 can be carried out on the item of equipment which is to be connected. The memory function provides that, upon actuation of the respective actuating lever 1 which triggers a movement transmission function, the associated table portion 23 or the associated table portions 23 is or are moved into preset positions. The normal movement transmission function is set for the foot switch 11 by an activation switch 27. The three actuating levers 1 can be moved in horizontal and vertical directions of movement in the manner of joysticks in predetermined directions. For that purpose the actuating levers are mounted pivotably on the foot switch. As shown in FIG. 3 the actuating levers 1 in their normal (neutral) positions are arranged to project radially from a peripheral surface portion 22, formed at the outside of the foot switch 11, of a circular truncated cone or a straight or slanting cylinder. The foot switch 11 is used for displacement of table portions 23, which are displaceable relative to each other, of a treatment table 24 for patients, in particular an operating theater table, as shown in FIG. 4. A treatment table of that kind is known for example from EP 0 873 740 B1.

The switches 3 of the foot switch 11 are connected to an electrical control device 25 in the lift pillar of the treatment table 24. In dependence on the respective switch positions, the control device 24 controls hydraulically actuated piston-cylinder units associated with the respective table portions 23 for carrying out the corresponding movements of those portions into the respective positions.

### LIST OF REFERENCES

1 actuating lever
2 guide device
3 switch
4 circuit board
5 housing portion
6 housing portion
7 movement transmission device
8 actuating device
9 actuating portions
10 pivot point
11 foot switch
12 biasing spring
13 guide ball
14 spring abutment
15 guide grooves
16 opening
17 connector plug strip
18 fixing plate
19 fixing points
20 central opening
21 cup-shaped opening
22 peripheral surface portion
23 table portions
24 treatment table
25 control device
26 memory switch
27 activation switch

1. A treatment table for patient treatment comprising a plurality of table elements and a positioning device for selectively setting the position of a respective table element, wherein the positioning device has a plurality of electrical switches or switching contacts with associated actuating portions with which selective positioning movements of the positioning device are controllable, characterised in that the positioning device is in the form of a foot switch (11) and has at least one actuating lever (1) whose movements which are predetermined in given directions by a guide device (2) can be transmitted to at least two switches (3) or at least two switching contacts.

2. A treatment table as set forth in claim 1 characterised in that the movement of the actuating lever (1) in a given direction can be transmitted simultaneously to the at least two switches (3) or the at least two switching contacts.

3. A treatment table as set forth in claim 1 characterised in that the foot switch (11) has a plurality of and in particular three actuating levers (1) with respectively associated switches (3) or switching contacts.

4. A treatment table as set forth in claim 1 characterised in that the actuating levers (1) are mounted movably in the manner of a joystick on the foot switch (1) in the predetermined directions of movement.

5. A treatment table as set forth in claim 1 characterised in that the actuating levers (1) are mounted pivotably on the foot switch (11).

6. A treatment table as set forth in claim 1 characterised in that the actuating levers (1) in their normal (neutral) positions are arranged to project radially from a peripheral surface portion (22), formed at the outside of the foot switch (11), of a circular truncated cone or a straight or slanting circular cylinder.

7. A treatment table as set forth in claim 1 characterised in that the guide device (2) predetermines mutually perpendicular directions of movement for the actuating lever (1).

8. A treatment table as set forth in claim 1 characterised in that there is provided a resiliently yielding movement transmission device (7) which transmits the movement of the actuating lever (1) to a mechanical actuating device (8) which selectively actuates at least one of the switches (3) or at least one of the switching contacts.

9. A treatment table as set forth in claim 8 characterised in that the movement transmission device (7) is fixed to the actuating lever (1).

10. A treatment table as set forth in claim 8 characterised in that the mechanical actuating device (8) has a plurality of actuating portions (9) which are to be actuated from a rest position into an actuating position by the movement transmission device (7).

11. A treatment table as set forth in claim 10 characterised in that the actuating portions (9) are resiliently biased in their respective rest positions.

12. A treatment table as set forth in claim 8 characterised in that the actuating device (8) comprises a plate-shaped portion and is arranged fixedly with respect to the housing.

13. A treatment table as set forth in claim 8 characterised in that the movement transmission device (7) comprises a foam material.

14. A treatment table as set forth in claim 8 characterised in that the movement transmission device (7) comprises a cylindrical body.

15. A treatment table as set forth in claim 1 characterised in that the guide device (2) predetermines four directions of movement for the actuating lever (1).

16. A treatment table as set forth in claim 15 characterised in that the four directions of movement are respectively spaced from each other at a right angle.

17. A treatment table as set forth in claim 8 characterised in that the movement transmission device (7) is fixed at the end which is in the housing (5, 6) or in the proximity of the end which is in the housing (5, 6), of the actuating lever (1).

18. A treatment table as set forth in claim 1 characterised in that the actuating lever (1) is movable about a pivot point (10) which is fixed with respect to the housing.

19. A treatment table as set forth in claim 17 characterised in that the movement transmission device (7) is fixed to the actuating lever (1) at a spacing from the pivot point (1O).

20. A treatment table as set forth in claim 1 characterised in that the actuating lever (1) is resiliently biased into its starting position with respect to the guide device (2) which is fixed with respect to the housing.

21. A treatment table as set forth in claim 1 characterised in that two horizontal actuating devices and two vertical actuating devices for the actuating lever (1) are provided in the foot switch (11).

22. A treatment table as set forth in claim 1 characterised in that a memory function by which the table portions (23) are movable into predetermined positions upon actuation of the respectively associated actuating levers (1) can be selected at the foot switch (11).
